(19) United States
(12) Patent Application Publication
(10) Pub. No.: US 2022/0245451 A1
(43) Pub. Date: Aug. 4, 2022

(54) Deep Neural Network Learning With Controllable Rules

(71) Applicant: Google LLC, Mountain View, CA (US)

(72) Inventors: Sercan Omer Arik, San Francisco, CA (US); Sungyong Seo, Glendale, CA (US); Minho Jin, San Jose, CA (US); Jinsung Yoon, San Jose, CA (US); Tomas Pfister, Redwood Shores, CA (US)

(21) Appl. No.: 17/591,845

(22) Filed: Feb. 3, 2022

Related U.S. Application Data
(60) Provisional application No. 63/145,744, filed on Feb. 4, 2021.

(51) Int. Cl. G06N 3/08; G06N 3/04

(52) U.S. Cl. CPC G06N 3/08; G06N 3/0427

(57) ABSTRACT

The present disclosure provides a method to integrate prior knowledge (referred to as rules) into deep learning in a way that can be controllable at inference without retraining or tuning the model. Deep Neural Networks with Controllable Rule Representations (DNN-CRR) incorporate a rule encoder into the model architecture, which is coupled with a corresponding rule-based objective for enabling a shared representation to be used in decision making by learning both the original task and the rule. DNN-CRR is agnostic to data type and encoder architecture and can be applied to any kind of rule defined for inputs and/or outputs. In real-world domains where incorporating rules is critical, such as prediction tasks in Physics, Retail, and Healthcare.

### CROSS-REFERENCE TO RELATED APPLICATIONS

The present application claims the benefit of the filing date of U.S. Provisional Patent Application No. 63/145,744 filed Feb. 4, 2021, the disclosure of which is hereby incorporated herein by reference.

### BACKGROUND

Neural networks are machine learning models that include one or more layers of nonlinear operations to predict an output for a received input. In addition to an input layer and an output layer, some neural networks, called deep neural networks (DNNs) include one or more hidden layers.

DNNs have shown state-of-the-art performance across numerous tasks such as image classification, machine translation, and medical image segmentation. DNNs are known to yield better performance over other machine learning approaches as the size and coverage of high-quality labeled training data increases. However, in many real-world applications, such high-quality datasets may be infeasible to construct. Often, within a domain for a real-world application, there exists prior knowledge or rules in a form that is not labeled data. Rules can include natural laws, heuristics, equations, logic statements, constraints, exclusion lists or blocked lists, etc. DNNs can be trained to perform a task using these rules and in addition to training data.

To incorporate rules into deep learning, various methods have been studied. One is the posterior regularization approach to inject rules into predictions. Other methods include a teacher student framework, where the teacher network is obtained by projecting the student network to a (logic) rule-regularized subspace and the student network is updated to balance between emulating the teacher's output and predicting the true labels. Another approach is a Lagrangian Dual Framework, in which Lagrangian duality is exploited to train with rules. In these and other methods, a neural network trained with rules and training data must be retrained to incorporate new or updated rules.

### BRIEF SUMMARY

Aspects of the disclosure provide for training a machine learning model that can adaptively adjust how a set of rules are applied to it at inference. A Deep Neural Network with Controllable Rule Representations (DNN-CRR) system enables joint learning from both labeled data and rules, by implementing respective separate encoders to generate rule-based and data-based representation of input data. The same neural network can generate different output according to different control parameter values adjusting the strength of a set of rules on network output, without requiring that the neural network be retrained or tuned in between applying different control parameter values. Additionally, the DNN-CRR system enables use cases such as hypothesis testing of rules on data samples, and unsupervised adaptation of the same network on different datasets, based on shared rules.

The DNN-CRR system is model-agnostic, task-agnostic, and rule-agnostic. The system is applicable to a variety of different domains, where higher accuracy in performing a task can be achieved through variable adherence to a set of rules, as compared with neural networks in which rules may only be strictly applied, or not applied at all.

Aspects of the disclosure provide for a system including one or more processors, the one or more processors configured to: train, by the one or more processors, a machine learning model to process input data, wherein the machine learning model is trained to: receive input data; receive a control parameter value corresponding to a degree at which output data generated by the machine learning model adheres to one or more rules; and generate the output data in accordance with a machine learning task, using the input data, the control parameter value, and the one or more rules.

This and other aspects of the disclosure can provide for a number of technical advantages. A machine learning model can be trained once and able to receive a control parameter value to adjust the strength at which the one or more rules are applied by the model when generating the output data. Because the control parameter value can be received by the trained model, retraining the model is not necessary. Computational costs in training the model, for example measured in processing cycles, processing time, and/or memory bandwidth utilization, can be reduced, at least because the model does not have to be retrained in between applying different control parameter values. A system as described herein can function more efficiently at least because computational costs otherwise incurred during training can be allocated to perform other tasks.

Aspects of the disclosure provide for a method, the method including training, by one or more processors, a machine learning model to: receive input data; receive a control parameter value corresponding to a degree at which output data generated by the machine learning model adheres to one or more rules; and generate the output data in accordance with a machine learning task, using the input data, the control parameter value, and the one or more rules.

Aspects of the disclosure provide for one or more non-transitory computer-readable storage media storing instructions that when executed by one or more processors causes the one or more processors to perform operations including: training, by the one or more processors, a machine learning model to process input data, wherein the machine learning model is trained to: receive input data; receive a control parameter value corresponding to a degree at which output data generated by the machine learning model adheres to one or more rules; and generate the output data in accordance with a machine learning task, using the input data, the control parameter value, and the one or more rules.

These and other aspects of the disclosure can include one or more optional features, including the features described below. In some examples, aspects of the disclosure include all of the following features together in combination.

The one or more processors are further configured to: receive a first control parameter value and first input data; process the first input data to generate first output data using the trained machine learning model, the first control parameter value, and the one or more rules; receive a second control parameter value and second input data, the first control parameter value different from the second control parameter value; and process the second input data to generate second output data using the trained machine learning model, the second control parameter value, and the one or more rules.

The trained machine learning model includes model parameter values, and wherein the model parameter values for the machine learning model are not updated in between processing the first input data and the second input data.

The machine learning model includes a rule encoder, a data encoder, and a decision block, and wherein in training the machine learning model, the one or more processors are configured to: generate a data latent representation of the input data using the data encoder and a rule latent representation of the input data using the rule encoder; concatenate the data latent representation and the rule latent representation using a control parameter value sampled from a probability distribution to generate a concatenated representation; generate, from the decision block receiving the concatenated representation, output data corresponding to the input data; and update model parameter values for one or more of the rule encoder, the data encoder, and the decision block, based at least in part on an error calculated between the output data and a ground-truth label.

In training the machine learning model, the one or more processors are configured to perform one or more iterations of generating the data latent representation and the rule latent representation, concatenating the data latent representation and the rule latent representation, and generating the output data from the decision block receiving the concatenated representation, and wherein for each iteration of the one or more iterations, the one or more processors are configured to sample a respective control parameter value from a probability distribution.

The one or more processors are configured to sample from the probability distribution weighted to sample zero or one at the ends of the sampled range more often than values within the sampled range that are not zero or one.

In training the machine learning model, the one or more processors are configured to: train the machine learning model using a compound objective function comprising a task-based objective function and a rule-based objective function, wherein the output of the rule-based objective function is scaled according to the sampled control parameter value.

The machine learning model includes model parameters, wherein the rule-based objective function is non-differentiable with respect to model parameter values of the machine learning model, and wherein the one or more processors are configured to: receive a training example; perturb the training example according to a predetermined factor; and process the rule-based objective function using at least the training example and the perturbed training example, wherein the output of the rule-based objective function is based on whether the training example and the perturbed training example adhere to the one or more rules.

The one or more processors are further configured to: receive a rule verification ratio threshold; and search a plurality of control parameter values for a target control parameter value that causes the trained machine learning model to generate output with a rule verification ratio meeting or exceeding the rule verification ratio threshold.

In determining the target control parameter value, the one or more processors are further configured to: receive a maximum error rate threshold specifying a maximum error rate for output data generated by the trained machine learning model; and search for a target control parameter value that causes the trained machine learning model to generate output data with the rule verification ratio meeting or exceeding the rule verification ratio threshold and having an accuracy meeting or exceeding the maximum error rate.

The machine learning model is a deep neural network.

Aspects of the disclosure provide for a system including one or more processors configured to: receive, by the one or more processors, input data for processing at a machine learning model trained to receive a control parameter value corresponding to a degree at which output data generated by a machine learning model adheres to one or more rules; receive, by the one or more processors, a control parameter value; and generate, by the one or more processors and from the machine learning model, output data using the input data and the control parameter value.

### BRIEF DESCRIPTION OF THE DRAWINGS

FIG. 1 is a schematic diagram of an example method performed by a DNN-CRR system, according to aspects of the disclosure.

FIG. 2 is a block diagram of an example implementation of the DNN-CRR system.

FIG. 3 is a flow diagram of an example process for training a neural network with controllable rule representation.

FIG. 4 is an example process for processing input at a machine learning model trained for controllable rule representation, according to aspects of the disclosure.

FIG. 5 is a flow diagram of an example process for training a machine learning using the DNN-CRR system and input perturbation.

FIG. 6 is a flow diagram of an example process for searching for a target control parameter value, according to aspects of the disclosure.

FIGS. 7A-B are graphs illustrating experimental results for an example DNN-CRR system trained to predict future states of a double pendulum, comparing the DNN-CRR system with other training baselines.

FIGS. 8A-C are graphs illustrating average model errors for the DNN-CRR system, according to different rules.

FIGS. 9A-C are graphs illustrating average model errors of the DNN-CRR system on unseen test data sets.

FIGS. 10A-D are graphs illustrating cross-entropy loss of the DNN-CRR system on different input datasets with a distribution shift.

FIGS. 11A-11B are graphs comparing cross-entropy and model accuracy versus rule strength for various upper bounds of a perturbation scale.

FIGS. 12A and 12B show an example of the DNN-CRR system implemented on one or more computing devices.

### DETAILED DESCRIPTION

### Overview

Aspects of the disclosure provide for training a neural network that can adaptively change how it applies a set of rules at inference. A Deep Neural Network with Controllable Rule Representations (“DNN-CRR”) system generates representations of input data using a rule encoder and a task encoder. The task encoder is trained to generate a latent representation of the input data for accurately generating output data from the input data in accordance with a machine learning task. A rule encoder is trained to generate a latent representation of the input data based on a set of rules.

A latent representation is a set of values for one or more features generated by the encoders and is used in intermediate operations, for example operations performed at one or more hidden layers, before a network generates an output by an output layer. The latent representation may be a set of values having a lower dimensionality than the input data.

The rule encoder is trained to generate a rule latent representation, which is processed at a downstream decision block of the neural network for generating output data adhering to the rules at varying degrees. The task encoder is trained to generate a data latent representation, which is processed by the decision block of the neural network for generating accurate output data with respect to the task the neural network is being trained to perform.

Using a received control parameter value at inference, the DNN-CRR system can generate outputs from a combination of the different representations, with different trade-offs between neural network accuracy with respect to the machine learning task, and how often generated output adheres to the set of rules.

Rules can refer to a number of requirements, heuristics, guidelines, logical propositions, or other constraints imposed on a neural network to guide the generation of output for a particular domain. Rules may be derived from experimental data or observations made in such domains as in physics, healthcare, information technology or security, finance, etc. Rules can be applicable for all given input to the system, or applicable only to subsets of the given input.

Example rules include:
(1) The probability of the j-th class ŷⱼ is higher when a<xₖ where a is a constant and xₖ is the k-th feature.
(2) The number of sales is increased when the price of an item is decreased.
(3) Eₜ>Eₜ₊₁, where Eₜ is the energy of an object in a physical system at timestep t (the law of conservation of energy in classical physics).

Rules can be expressed, for example, as a combination of equations and mathematical expressions, natural language statements, formal logic statements, or as a computer program or script. Rules may be provided, for example, as user input prior to training a neural network.

Output from a neural network that does not violate the set of rules is said to adhere to the rules. Rule strength refers to the degree at which output data from the model adheres to a rule. One measure of rule strength is a rule verification ratio. A rule verification ratio is a fraction between 0 and 1 representing the number of instances of network output generated by the DNN-CRR system that adhere to the rules, over the total number of instances of network output generated by the DNN-CRR system. A rule verification ratio of 1 indicates the network is generating output that strictly adheres to the set of rules. A rule verification ratio of 0 indicates that the network is generating output that does not adhere to the set of rules at all. To adjust the rule strength at inference, a control parameter value is provided to the DNN-CRR system, according to aspects of the disclosure.

The DNN-CRR system as described herein can train a deep neural network (or other types of machine learning models) to receive a control parameter value corresponding to a desired rule strength at which incorporated rules to the system are applied to network output. In between receiving different control parameter values, model parameter updates, for example during retraining or fine-tuning a trained neural network, may not be performed.

Various different control parameter values can be sampled according to a distribution, during training, for generating different latent representations concatenated from portions of the rule latent representation and the data latent representation generated by the network's encoders. The variety of different latent representations the system is exposed to during training can improve network output quality, measured for example by network accuracy with respect to ground-truth labels, and by a rule verification ratio. During inference, concatenated latent representations are generated according to a received control parameter value.

Aspects of the disclosure provide for at least the following technical advantages. A deep neural network can be trained and deployed, for example on a personal computing device or on a server, to accurately generate output in accordance with a machine learning task. Downstream devices can benefit from the generated output, to improve their own processes, for example by generating more accurate output of their own.

Controllable rule representations allow for more efficient searching of different breakpoints between model quality and rule verification, at least because a network trained with incorporated rules does not need to be retrained for new control parameter values. Desired trade-offs between network accuracy and rule strength can vary from dataset to dataset. The DNN-CRR system can be used to search for control parameter values adjusting the strength of rules on model output, to achieve those desired trade-offs, for example a minimum accuracy rate and/or verification ratio. Computing resources, for example processor clock cycles or memory bandwidth of various computing devices, can be used more efficiently, at least because resources are not wasted for retraining a network.

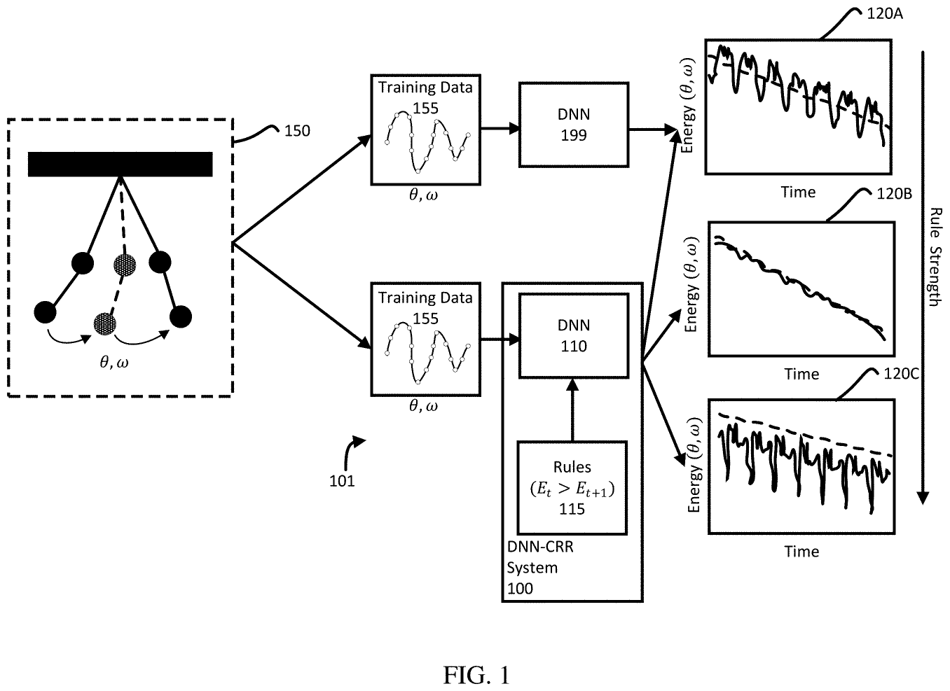

In some examples, strict adherence to rules is desired, for example when a neural network is trained to simulate a classical physical system (FIG. 1). Even in those domains in which strict adherence may be more desired, controllable adherence to the rules by different degrees of strength can provide for identifying optimal trade-offs on a per sample or data set basis. For example, if there are training examples that are very similar to a particular test sample, a weaker rule-driven contribution would be desirable at inference. This is at least because higher rule strength may cause the network to divert from generating an otherwise more accurate output for the given test example.

In some examples, strict adherence to a set of rules is not desired. In sales forecasting, rules may be more like contextual guidelines or heuristics than immutable natural laws. Further, the “rules” identified for sales forecasting may only be applicable on subsets of input data. The DNN-CRR system allows for using the same network, for example trained for sales prediction, to generate different output in which the rules are adhered to varying degrees. In other examples, the degree of strength of rules on a neural network trained for achieving a desired tradeoff between network accuracy and rule strength is not known, requiring the network to be flexible to generating output in accordance with different rule strengths.

DNN-CRR as described herein can be performed on any of a variety of different machine learning model types, rules formulated in various ways, and on different types of datasets. Because DNN-CRR is model-, rule-, and data-agnostic, existing systems and platforms configured to perform tasks benefitting from rule incorporation can be augmented to provide for controllable rule incorporation at inference. Although the description herein refers to deep neural networks, it is noted that other types of machine learning models, including other types of neural networks, may be used in various examples. Network reuse can reduce wasted computing resources otherwise used for tuning or retraining a network to adapt to different datasets. This has a direct effect on the performance of the system and downstream processes, as downtime for updating the model is reduced or eliminated.

Although examples herein are provided with reference to deep neural networks, aspects of the disclosure can be applied to any type of machine learning model that can be trained with a gradient descent-based optimization technique. Examples include soft decision trees and linear regression models.

In addition to handling different datasets, a DNN-CRR system as described herein can also be adjusted at inference to apply incorporated rules at different degrees of strength when handling time-series data. Over time, the distribution of values across the time-series data may change—known as distribution shift. As a result of this shift, certain rules previously incorporated during time-series data for forecasting may be more or less applicable for time-series data later in time.

Further, the DNN-CRR system can receive and incorporate both differentiable and non-differentiable rules with respect to the learned model parameter values.

The versatility of the DNN-CRR system may be demonstrated on machine learning tasks from physics, retail, and healthcare. A network whose output is adjusted based on predetermined rules may be adopted more easily in practice than a network whose output is based solely on learned relationships in labeled training data. Aspects of the disclosure provide for increased verification of network output, at least because rule strength can be quickly adjusted to observe how the rules impact network output. By being able to efficiently adjust rule strength at inference, the network output in relation to different rule strengths can be measured and analyzed, providing improved insight into how the network generates output. This improved insight can be a direct benefit in the design of downstream processes using data generated by the network, allowing dependent devices to perform more accurately and/or efficiently.

Controllable rule representations as described herein enables gradual application of rule-based machine learning models in fields often relying on hand-crafted rules, such as enterprises in finance, healthcare, technical support, or the public sector. To augment decision-making by these enterprises using artificial intelligence, a deep neural network trained with controllable rule representation can be implemented to gradually learn to perform a task while relying on this accumulated domain knowledge. As described herein, even rules initially formulated as non-differentiable constraints can be incorporated by a deep neural network with controllable rule strength at inference.

Controlling rule strength at inference can improve the robustness of deep neural networks, for example by enabling trained models capable of handling edge cases more predictably versus networks trained without controllable rule representations. Incorporating rules can help to constrain a model search space, reducing sensitivity to minor changes in inputs that may be imperceptible to manual analysis but nonetheless dramatically alter model output in unexpected ways. Controlling rule strength can also help to test hypotheses as to the relationship between model input and output, which can help improve model explainability and in turn allow for a model that is more dependable, because the relationship between its input and output can be better understood through its relationship to varying strengths of incorporated rules.

### Example Systems

FIG. 1 is a schematic diagram of an example data processing flow of which a DNN-CRR system 100 is a part of , according to aspects of the disclosure.

Observations from a physical system 150 can be recorded and provided as training data 155. In the example shown in FIG. 1, the physical system 150 is a double pendulum system. The training data 155 includes training examples representing the angular displacement and angular velocities of the pendulums at different timesteps. A timestep is a point in time, which can be measured in seconds, milliseconds, etc., relative to an initial timestep, such as timestep t=0. The training examples are labeled with states representing the displacement and velocities of the pendulums at a future point in time, for example timestep t+1, t+2, etc.

A deep neural network (DNN) 199 can be trained using the training data 155 to predict future displacements and velocities of a double pendulum given only its input state. In contrast to DNN 110 of the system 100, DNN 199 is trained using only the training data, and without rules 115.

As shown in graph 120A of FIG. 1, training the DNN 199 only on the training data 155 can result in the DNN 199 predicting future states of the double pendulum that violate rules of classical physics. One such rule is the law of conservation of energy (Eₜ>Eₜ₊₁, where Eₜ is the energy of the physical system 150 at timestep t). In the graphs 120A-120C, the y-axis tracks energy of the system, increasing with the distance from the origin in the lower-left hand corner of the graphs 120A-C. The x-axis tracks time, with future timesteps represented further from the origin. The dotted curves correspond to the energy level of the double pendulum in a future state predicted by the DNN 110. In the top graph 120A, the rules have zero strength over the output of the DNN 110. The DNN 110 predicts multiple output states in which the energy level of the system at a future timestep (Eₜ₊₁, in dashed curves) exceeds the energy level of a current timestep (Eₜ in solid curves), in violation of the law of conservation of energy.

The graphs 120A-C are presented in descending order, according to the strength of the rules 115 on the output of the DNN 110 at inference. In a middle graph 120B, the energy of predicted states adheres more frequently—but not completely—with the law of conservation of energy. The bottom graph 120C illustrates energy levels of predicted states from the DNN-CRR system 100, set to strictly adhere to the law of conservation of energy. In the bottom graph 120C, the curves tracking current and future energy levels of the system are separate, with the dashed curve representing the energy level of the system at a current timestep strictly greater than the energy level of the system at a future timestep.

Once trained, the DNN-CRR system 100 can receive different control parameter values for adjusting the strength of the rules 115. In other words, the DNN-CRR system can produce output consistent with output whose energy is represented in any of graphs 120A-120C, and other trade-offs not shown in FIG. 1. The adjustment from partial or no adherence to strict adherence (vice versa) can be performed after the DNN 110 has been trained and deployed on one or more computing devices.

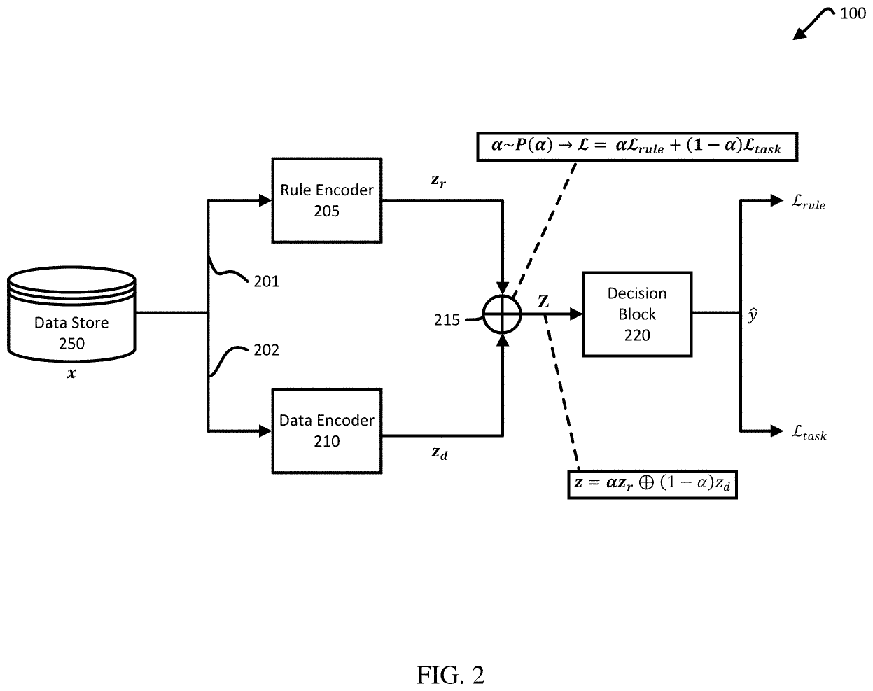

FIG. 2 is a block diagram of an example implementation of the DNN-CRR system 100. The DNN-CRR system 100 includes a rule encoder 205, a data encoder 210, and a decision block 220. The rule encoder 205, the data encoder 210, and the decision block 220 can form at least part of the DNN 110. The system 100 can be trained using a two-passage approach for training data received from data store 250.

In the following and other examples, the DNN-CRR system 100 can be implemented on one or more processors and one or more memory devices housed in one or more physical devices. In some examples, the DNN-CRR system 100 may be part of a specialized workstation, for example configured for collecting medical data from a patient. In other examples, the DNN-CRR system 100 can be trained on one or more computing devices, and the resulting trained network can be distributed and deployed to a number of devices in a network coupled to the one or more training computing devices. In other examples, a network trained using the DNN-CRR system 100 can be deployed on a server having a client-server relationship with a number of client devices over a network. The server can receive requests including network input and control parameter values and generate and transmit network output in response to those requests.

In some examples, the DNN-CRR system 100 can be implemented as part of a data processing pipeline for medical diagnosis or treatment. The DNN-CRR system 100 can receive a combination of text, image, or video corresponding to the medical history and/or physiological measurements of a patient and predict whether the patient has a cardiovascular disease. An example rule that can be applied is: the probability of having a cardiovascular disease increases with higher systolic blood pressure. This example rule of higher systolic blood pressure leading to higher risk of cardiovascular disease may be more applicable or less applicable depending on the age of the patient.

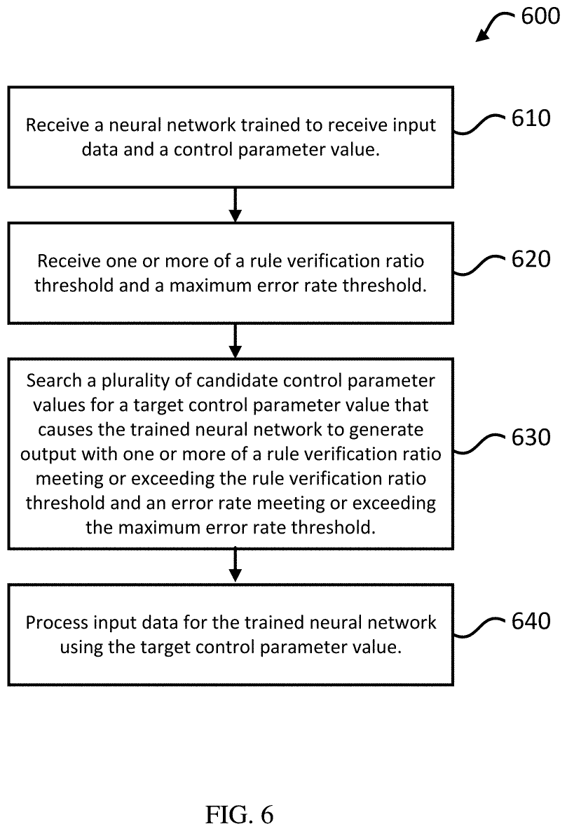

Continuing the example of the system 100 implemented for medical diagnosis, the DNN-CRR system 100 can receive different control parameter values to adjust the strength of this rule, depending on the age of the patient. In other words, for the same trained network, the rule of higher systolic blood pressure leading to increased risk of cardiovascular disease can generate different output depending on whether the patient being analyzed is young (associated with lower rule strength) or old (associated with higher rule strength). As described herein with reference to FIG. 6, the DNN-CRR system 100 can be used to search for a control parameter value that best balances rule strength with model accuracy according to a predetermined trade-off point, to account for different data distributions, such physiological measurements from patients in different age groups.

As another example and as described herein with reference to FIG. 1, the DNN-CRR system 100 can be used to train a DNN to simulate a physical system. The physical system can be tasked to, for example, predict characteristics of different materials under different physical conditions. The predicted characteristics or other output can be used in a downstream process for designing, manufacturing, or fabricating a product built from the simulated materials.

As another example, the DNN-CRR system 100 can be implemented as part of a financial analysis system. For example, the DNN-CRR system 100 can train a DNN for forecasting daily and weekly sales of goods or services. An example rule can be: “price-difference and sales-difference should have a negative correlation coefficient:

$$r = \frac{Δ S A L E S}{Δ PRICE} < 0.0 .$$

These and other rules for financial analysis may be “soft,” in that only certain goods or services whose sale is analyzed follow certain rules, while other goods or services do not. For evaluating different goods or services, the rule strength of the incorporated rules can be adjusted on the same trained network.

As another example, the DNN-CRR system 100 can be implemented as part of a computer network monitoring and security system. The DNN-CRR system 100 can receive data quantifying characteristics of computer network and data traffic among interconnected devices. This data can include activity logs, as well as records of access privileges for different computing devices to access different sources of potentially sensitive data. A neural network can be trained for processing these and other types of documents for predicting on-going and future security breaches to the network. For example, the neural network can be trained to predict intrusion into the network by a malicious actor. Predicting intrusion of a computer network by a malicious actor can mitigate or eliminate service interruptions for services provided by the computer network.

Applicable rules can include certain characteristics of network traffic that historically have posed risks to the security of the network being monitored. Rules may be expressed as regular expressions over network traffic logs. Network traffic logs recording activity indicative of potential malicious activity may follow a similar format when recorded, indicated by the regular expression.

The DNN-CRR system 100 can train a DNN to predict the presence of malicious network activity. As the threat of malicious activity increases or decreases, the DNN-CRR system 100 can receive input to adjust the rule strength of the regular expression in predicting malicious activity. One reason for this can be because the regular expression expresses text that may appear in benign network activity logs, which can potentially result in false positive classification of malicious activity. At least because the trained DNN does not have to be tuned or retrained for controlling the application of the rules, potential downtime of the monitoring system can be reduced. In addition, the trained DNN can be more quickly adapted in response to changes in attack strategies or the behavior of malicious actors. For example, if a popular attack strategy for the network by a malicious actor can be more easily identified by stricter adherence of a certain rule incorporated in the DNN, the DNN can be tuned with a control parameter value at inference to rely on that rule more often in detecting the occurrence of the attack strategy. Therefore, the chance of an intervening malicious event occurring undetected during downtime is also reduced.

Training data for training the DNN 110 can be one or more training examples, for example, a mini batch of training examples representing some subset of the total training data, or a set of training data. An example mini-batch size is 32 examples, but more or fewer examples per batch are possible. Individual training examples can be represented as tensors, matrices, vectors, or any of a variety of different data structures storing a number of feature values. A feature is a quantifiable characteristic of a training example. Non-limiting examples for feature values for a feature can be a number (for example, 6′0″ for a feature representing the height of a training example representing a patient), or a category (for example, the category “diabetic” for a feature representing whether or not a patient represented by the training example has diabetes).

The DNN-CRR system 100 is trained using a compound objective function based on two separate objective functions. An objective function (“objective”) represents the machine learning task the system is being trained to perform. The objective is used to evaluate the performance of a machine learning model during training. During training the DNN-CRR system 100 uses the compound objective to compute a loss value between output of the system during training for a set of input training examples, and a true output (or “ground truth”) label for each of the input training examples. The goal of training is to minimize error in the network, by adjusting model parameter values for the system, such as weights or bias values.

The compound objective used by the DNN-CRR system can be based on two other objectives, a task-based objective, and a rule-based objective. The task-based objective represents the machine learning task to be performed. The task-based objective is used during training to compute the loss between the output of the system and corresponding ground-truth labels for given input data. Non-limiting examples of machine learning tasks a machine learning model can be trained to perform are described, herein, with reference to FIGS. 1-2. The rule-based objective is used during training to measure how close network output adheres to a set of provided rules for the given training data.

Copies of the training data pass through both a first passage 201 and a second passage 202 of data. The first passage 201 includes a rule encoder 205 and the second passage 202 includes a data encoder 210. The data encoder 210 generates data latent representations from the training data and the rule encoder 205 generates rule latent representations from the training data.

After the rule and data latent representations are generated, the system 100 randomly concatenates rule and data latent representations according to a probability distribution, shown by the ⊕ operation 215 in FIG. 2. A control parameter value a is sampled from a probability distribution and is used to concatenate the rule and data latent representations. During training, the control parameter can be sampled at each training iteration, according to the probability distribution.

The concatenation operation 215 scales the rule latent representation according to the sampled control parameter value and may also scale the data latent representation by a factor based on the control parameter value, for example with value (1−a). By using multiple sampled control parameter values during training, the DNN 110 is exposed to a range of latent representations in which the rule latent representation is represented more heavily or less heavily relative to the data latent representation. This exposure to different control parameter values during training can enable the system 100 to flexibly adapt to different control parameter values at inference. In other examples, the latent representations can be added to one another, and/or processed as a function of operations including concatenation, addition, etc.

At inference, the decision block 220 receives the concatenated latent representation and generates a model output. Each of the decision block 220, the rule encoder 205, the data encoder 210 may be of a similar model architecture, for example a multilayer perceptron, or of different model architectures. Each of the rule encoder 205, data encoder 210, and decision block 220 can be any of a variety of model architectures. In some examples, such as when the DNN-CRR system 100 is trained for simulating a physical system, the rule encoder may be a three-layer network, where each layer is a fully-connected layer with 64 units, and the activation function used is Rectified Linear Unit (ReLU). In some examples, the final layer of the decision block 220 can be a softmax layer.

Other example configurations are possible, for example with more or fewer units, different activation functions, and different quantities of layers in each of the rule encoder 205, data encoder 210, and decision block 220. In some examples, input data can be provided to both the rule and data encoder through a shared layer (not shown in FIG. 2). The shared layer may include two neural network layers, for example a 64 unit fully connected layer with ReLU, followed by a 16 unit fully connected layer that passes its output to the data and rule encoders.

In some examples, different forms of encoding are applied by the DNN-CRR system 100 to input data, such as one-hot encoding for categorical data. Various optimization methods for training can also be used in conjunction with aspects of the disclosure, such as the Adam optimization algorithm.

During training, the decision block 220 generates a predicted output for the training data, using the concatenated latent representations. The system 100, using the compound objective, computes a loss between the predicted output from the decision block 220 and a ground-truth label for each training example in the training data. The system can use the loss as part of a training process, such as backpropagation with stochastic, minibatch, or batch gradient descent, to update model parameter values of the decision block 220 and/or the encoders 210, 215.

The system 100 can perform multiple iterations of backpropagation with gradient descent and model parameter update, until predetermined convergence criteria are met. The convergence criteria can include, for example, a maximum number of iterations of backpropagation, gradient descent, and model parameter update. The convergence criteria can additionally or alternatively define a minimum improvement between training iterations, for example measured by a relative or absolute reduction in the computed error between output predicted by the system 100 and corresponding ground-truth labels on training data reserved for validation. In some examples, the system 100 can be trained for 1000 epochs with early stopping where a validation error is not improved for 10 epochs. Other convergence criteria can be based on a maximum amount of computing resources allocated for training, for example a total amount of training time exceeded, or total number of processing cycles consumed, after which training is terminated.

It has been observed that DNNs trained as described herein can generate more accurate output versus other approaches in which a range of control parameter values are not sampled during training. It has also been observed that DNNs trained as described herein improve in performance, measured for example by network accuracy, even when the rule strength is minimal or zero (a=0). One reason for this improvement is that the number of latent representations received by the decision block is increased with the various concatenations of the data and rule latent representations, providing more efficient supervision for training overall.

TABLE 1 shows an example training process for training the DNN-CRR system 100.

TABLE 1

| | Input: Training data D = {(xᵢ,yᵢ): i = 1, ... , N}. |
|---|---|
| | Output: Parameters for trained DNN-CRR system |
| | Additional Input: Rule encoder ϕᵣ, data encoder ϕ_{d}, decision block |
| | ϕ, and probability distribution P(α). |
| 1 | Initialize ϕᵣ, ϕ_{d}, and ϕ |
| 2 | While not converged do |
| 3 | Receive mini-batch D_{b} from D and α_{b} ∈ R from P(α). |
| 4 | Receive z = α_{b}zᵣ ⊕ (1 − α_{b})z_{d} where zᵣ = ϕᵣ(D_{b}) and z_{d} = ϕ_{d}(D_{b}). |
| 5 | $\begin{matrix}Receive \hat{y} = ϕ ( z ) and compute L = {E}_{α \sim P ( α )} [ α {L}_{rule} + ρ ( 1 - α ) {L}_{task} ] , \\ where ρ = \frac{{L}_{rule , 0}}{{L}_{task , 0}}\end{matrix}$ |
| 6 | Update ϕᵣ, ϕ_{d}, and ϕ from gradients ∇_{ϕ}_{ᵣ}L, ∇_{ϕ}_{_{d}}L, and ∇_{ϕ}L |
| 7 | end while |

The input is the training data D, which includes a number of training examples. A training example i can be represented as a tuple (xᵢ, yᵢ), where xᵢ can represent a vector or other data structure of feature values corresponding to the training example i, and yᵢ is the label for the training example i.

The output includes parameters for the trained DNN-CRR system 100. Additional input for the process as shown in TABLE 1 include rule encoder ϕᵣ, data encoder ϕ_{d}, decision block ϕ, and probability distribution P(a). In some examples, the additional input is provided to the system 100 before the system 100 receives the training data. In other examples, the additional input is provided to the system 100 at the same time as the training data.

In line one of TABLE 1, the system 100 initializes the rule encoder ϕᵣ, the data encoder ϕ_{d}, and the decision block ϕ. For example, initialization can include randomly assigning values for each model parameter of the encoders and the decision block.

Lines two and seven of TABLE 1 define a loop in which the steps as shown by lines three through six are performed until convergence. As described herein, convergence can be defined according to one or more convergence criteria. As shown by line three of TABLE 1, the DNN-CRR system 100 receives a mini-batch D_{b} and a control parameter value a_{b} selected from the set of real numbers R in accordance with the probability distribution P(a).

In some examples, the probability distribution can be a uniform distribution between zero and one ([0,1]). In other examples, the probability distribution p(a) causes the system to sample more heavily on ends of the range (zero and one) than uniformly across the distribution. Sampling more heavily on ends of the distribution can improve the robustness of the trained neural network in processing input at inference when the control parameter value is close to zero or one. This is at least because weighting the distribution allows for more concatenated latent representations representing no adherence or strict adherence to the rules.

In some examples, instead of sampling from a probability distribution P(a), the system 100 can sample from a beta distribution Beta(β₁, β₂). The first operand β₁ represents a weight for sampling zero as a control parameter value. The second operand β₂ represents the weight for sampling one as a control parameter value. An example weight can be 0.1 for both β₁ and β₂. Other examples include 0.05, 0.4, 0.7 and 1.0. In some examples, the values for β₁ and β₂ can be different.

As shown by line four of TABLE 1, the DNN-CRR system 100 receives a concatenated latent representation z, in accordance with the rule latent representation zᵣ, the data latent representation z_{d}, and the sampled control parameter value a_{b}. As shown by line five of TABLE 1, the system receives the predicted output ŷ from the decision block ϕ receiving the concatenated latent representation z as input. As also shown by line five, the system 100 computes the compound objective as the expected error E for each training example (or, examples in which mini-batches of training examples are processed, an expected error with mini-batch approximation) in the training data D.

In some examples, the system 100 can automatically scale values generated by computing the rule and task objectives. By scaling the rule and task objective values, the system 100 can prevent the model parameter values updated during training from being dominated by either the rule or task objective. For example, the system 100 may become unbalanced if the values of the rule objective are much larger than the task objective.

To mitigate or reduce the risk of unbalance, in some examples, the system computes a value for a scale parameter ρ, for example as shown in line five of TABLE 1. Before training begins, the system 100 can compute the scale parameter value as a fraction

$$( \frac{{L}_{rule , 0}}{{L}_{task , 0}} )$$

of the initial loss values for the system 100 for both the rule-based objective L_{rule,0} and the task-based objective L_{task,0}. In examples in which the system 100 does not compute a scale parameter value prior to training, the scale parameter value can be set to one (ρ=1) or omitted from the calculation of the compound objective altogether. In some examples, the system recalculates the scale parameter after each epoch, for example because the initial loss values for the system 100 may not be representative of the final scale of the task- and rule-based objectives.

As shown by line six of TABLE 1, the system updates model parameter values for the rule encoder ϕᵣ, data encoder ϕ_{d}, and decision block ϕ from gradients with respect to the model parameters for the rule encoder ∇_{ϕ}_{ᵣ}L, the model parameters for the data encoder ∇_{ϕ}_{_{d}}L and the model parameters for the decision block (∇_{ϕ}L), respectively. The DNN-CRR system 100 can update the model parameter values for the model parameters, in accordance with the computed gradients.

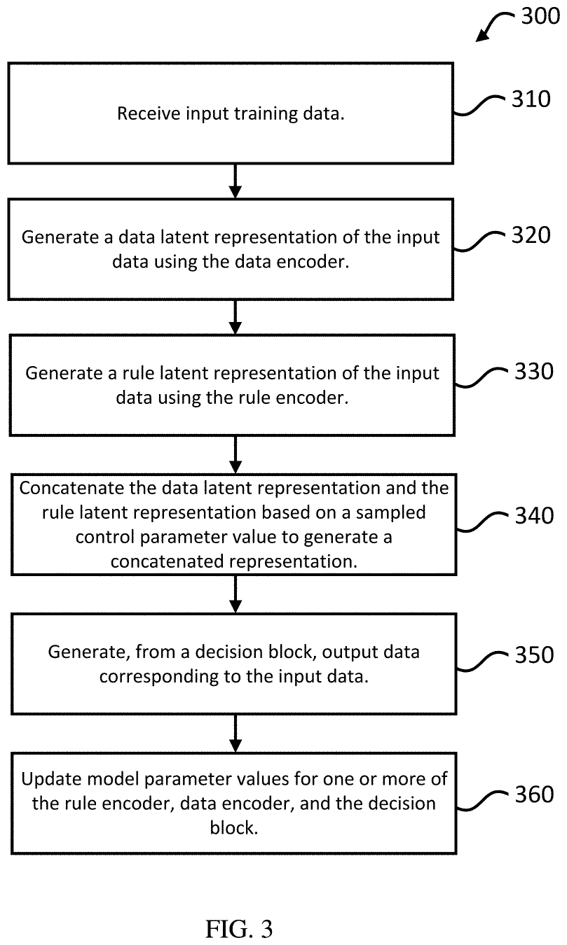

FIG. 3 is a flow diagram of an example process 300 for training a neural network with controllable rule representation. A system of one or more processors can perform the process 300. The process 300 can be a single iteration of a training process for training a DNN-CRR system. For example, the system can perform one or more iterations of the process 300 until meeting one or more convergence criteria.

The system receives input training data, according to block 310. The input training data is labeled and can be provided to the system one-by-one, as a batch, or as a mini-batch.

The system generates a data latent representation of the input data using a data encoder, according to block 320. The system generates a rule latent representation of the input data using a rule encoder, according to block 330.

The system concatenates the data latent representation and the rule latent representation based on a sampled control parameter value to generate a concatenated representation, according to block 340. The control parameter value is sampled according to a probability distribution, which may be weighted to sample more frequently at a=0 and a=1.

The system generates, from a decision block, output data corresponding to the input data, according to block 350. The system updates model parameter values for one or more of the rule encoder, data encoder, and the decision block, according to block 360. As part of updating the model parameter values, the system can compute a compound objective based on the sampled control parameter value, a rule-based objective, and a data-based objective. The sampled control parameter value is used to scale the output of the rule-based objective.

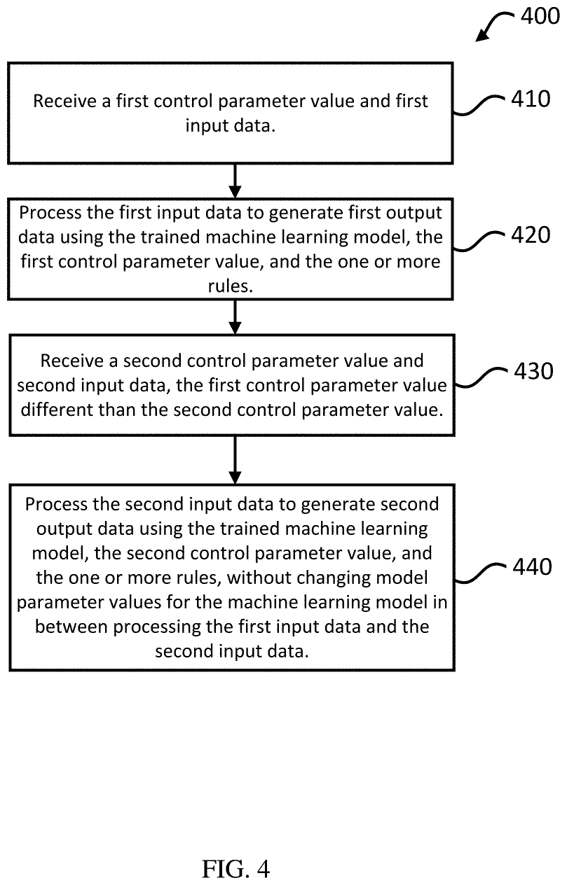

FIG. 4 is an example process 400 for processing input at a machine learning model trained for controllable rule representation, according to aspects of the disclosure.

The system receives a first control parameter value and first input data, according to block 410. The system processes the first input data to generate first output data using the trained machine learning model, the first control parameter value, and the one or more rules, according to block 420. The system receives a second control parameter value and second input data, the first control parameter value different from the second control parameter value, according to block 430. The system processes the second input data to generate second output data using the trained machine learning model, the second control parameter value, and the one or more rules, without updating model parameter values for the machine learning model in between processing the first input data and the second input data, according to block 440.

Incorporating Rules using Input Perturbation

In some examples, the rule-based objective may not be mathematically differentiable with respect to the model parameters of the DNN-CRR system 100. This may occur because the rules being incorporated into the DNN 110 are not initially provided in differentiable form. For instance, for a rule defined as r(x,ŷ)≤τ given a differentiable function r(⋅), the rule-based objective can be defined as Lᵣᵤₗₑ=max (r(x,ŷ)−τ,0) that has a penalty with an increasing amount as the violation increases.

However, many valuable rules for incorporating into the DNN-CRR system 100 may neither be differentiable with respect to the model parameters, nor can a continuous and differentiable rule-based objective be formed from those rules. For example, a rule may be an expressive statement represented as concatenations of Boolean rules, such as a fitted decision tree. Example rules of this type include:

(1) The probability of the j-th class ŷⱼ is higher when a<xₖ where a is a constant and xₖ is the k-th feature.

(2) The number of sales is increased when the price of an item is decreased.

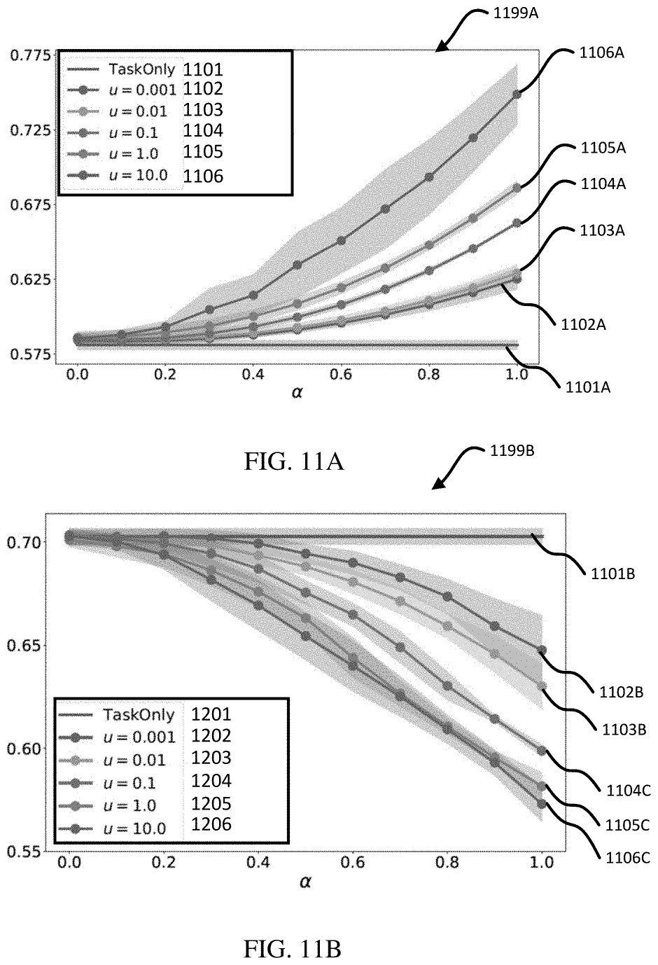

Aspects of the disclosure provide for input perturbation to generalize the DNN-CRR system 100 to handle non-differentiable rules. Input perturbation introduces a small perturbation or change to input data, to modify the original output and construct a corresponding rule-based objective for the output. The perturbation can be based on a predetermined perturbation value δ. One example construction of a perturbed input can be xₚ=x+δx, where the perturbed input xₚ is equal to the original input x plus the original input multiplied by a perturbation value δx. The perturbation value can be a scalar value sampled uniformly from a probability distribution. The range of the distribution can have a lower bound of zero and an upper bound u. An example upper bound u can be 0.1. FIGS. 11A-11B show example graphs comparing cross-entropy and network accuracy versus rule strength for various upper bounds.

As an example, to incorporate the first example rule (1), the perturbed input xₚ would be considered valid only when xₖ<a and a<x_{p,k}. The perturbed output ŷₚ is the output of the DNN-CRR system 100 when processing the perturbed input. The rule-based objective with the perturbed input can be:

Lᵣᵤₗₑ(x,xₚ,ŷⱼ,ŷ_{p,j})=ReLU(ŷⱼŷ_{p,j})·I(xₖ<a)·I(x_{p,k}>a). (1)

ReLU(⋅) is the rectified linear unit activation function, and I(⋅) is a function that returns 1 when the input predicate is true, and 0 otherwise. The output of evaluating the perturbation-based objective Lᵣᵤₗₑ(x,xₚ,ŷⱼ,ŷ_{p,j}) is zero when the original and perturbed inputs fail to satisfy the rule. For multiple rules, a corresponding loss function, such as ReLU, above, can be constructed for each rule, multiplied with functions returning one or zero depending on whether the rule is satisfied or not.

TABLE 2 shows an example training process for training the system 100 with perturbed integration of rules.

TABLE 2

| | Input: Training data D = {(xᵢ, yᵢ): i = 1, ... , N}. |
|---|---|
| | Output: Parameters for trained DNN-CRR system |
| | Additional Input: Rule encoder ϕᵣ, data encoder ϕ_{d}, decision block |
| | ϕ, and probability distribution P (α). |
| 1 | Initialize ϕᵣ, ϕ_{d}, and ϕ |
| 2 | While not converged do |
| 3 | Receive mini-batch D_{b} from D and α_{b} ∈ R from P (α). |
| 4 | Receive perturbed input xₚ = x + δx, where x ∈ D_{b}. |
| 5 | Receive y and yₚ from ϕᵣ, ϕ_{d}, ϕ, and α_{b}, respectively. |
| 6 | Define Lᵣᵤₗₑ = Lᵣᵤₗₑ (x, xₚ, ŷ, ŷₚ) based on a rule and Lₜₐₛₖ (y, ŷ) |
| | to generate L = α_{b} Lᵣᵤₗₑ + (1 − α_{b})Lₜₐₛₖ |
| 7 | Update ϕᵣ, ϕ_{d}, and ϕ from gradients ∇_{ϕ}_{ᵣ} L, ∇_{ϕ}_{_{d}} L, and ∇_{ϕ} L |
| 8 | end while |

As described herein with reference to TABLE 1, the system 100 receives the same input, output, and additional input in the training process shown by TABLE 2. As shown in line one of TABLE 2, the data encoder ϕ_{d}, rule encoder ϕᵣ, and decision block ϕ are initialized. Lines two through eight define a loop of operations performed by the system 100 until one or more convergence criteria are met.

As shown by line three, the system receives a mini-batch D_{b}. According to line four, the system generates a perturbed input xₚ=x+δx. According to line five, the system receives a network output y using the original input x, as well as a network output yₚ using the perturbed input xₚ.

As shown by line six, a rule-based objective is defined as a function of the input x, the perturbed input xₚ, the output y, and the network output yₚ. An example rule-based objective can be the rule-based objective (1), described above. Also, according to line six, the compound objective L is computed, using the rule-based objective Lᵣᵤₗₑ(x, xₚ,ŷ,ŷₚ) and the task-based objective Lₜₐₛₖ, as well as a sampled control parameter value.a_{b}. In line seven, model parameter values for the rule encoder, data encoder, and decision block are updated based on gradients computed using the compound objective with respect to the model parameters.

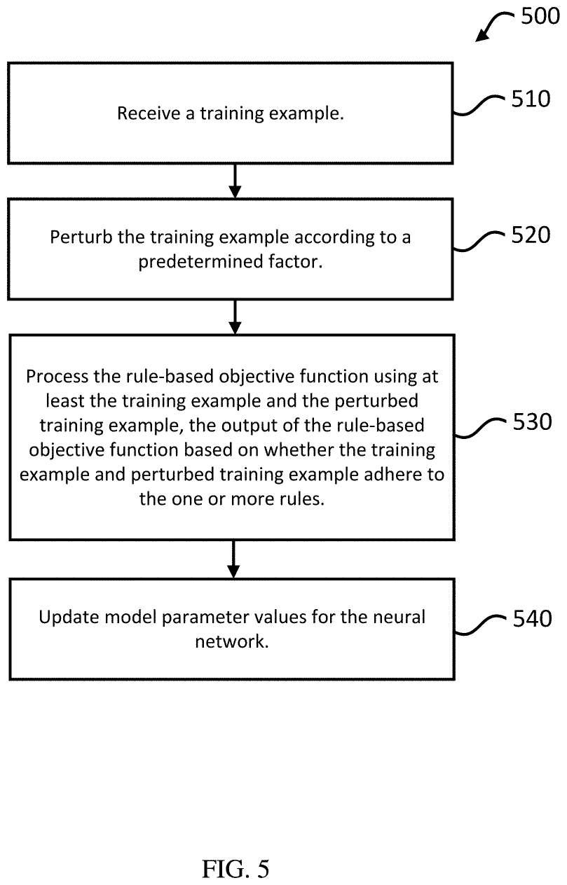

FIG. 5 is a flow diagram of an example process 500 for training a machine learning using the DNN-CRR system and input perturbation.

The system receives a training example, according to block 510. The system perturbs the training example according to a predetermined factor, according to block 520. The predetermined factor can be a perturbation value sampled from a distribution having a lower bound of zero and an upper bound u, as described herein with reference to TABLE 2.

The system processes the rule-based objective function using at least the training example and the perturbed training example, wherein the output of the rule-based objective function, based on whether the training example and perturbed training example adhere to the one or more rules, according to block 530. For example, the rule-based objective function can be the rule-based objective (3), described herein.

The system updates model parameter values for the neural network, according to block 540.

### Hypothesis Testing and Control Parameter Searching Using DNN-CRR

In some examples, a trade-off between rule strength and network accuracy may be desired, for example when the rules incorporated into a neural network are not strict natural laws and strictly adhered to. Even in the case of natural laws, such as the conservation of energy as described herein with reference to FIGS. 1-2, a network has been observed to perform more accurately without strict adherence to incorporated rules.

FIG. 6 is a flow diagram of an example process 600 for searching for a target control parameter value, according to aspects of the disclosure. A DNN-CRR system receives data specifying a neural network trained to receive input data and a control parameter value, according to block 610. The received data can include, for example, trained model parameter values and data specifying the architecture of the neural network, for example how many layers it has, what kind of layers, activation functions applied at each layer, etc. For example, the neural network can be a DNN trained for controllable rule representation, such as using the process 300 of FIG. 3 or as described herein with reference to TABLE 1.

The system receives one or more of a rule verification ratio threshold and a maximum error rate threshold, according to block 620. The rule verification ratio threshold can represent a minimum or maximum desired ratio at which the trained model is to generate output adhering to incorporated rules. The maximum error rate threshold can represent a maximum tolerated rate of errors by the network in generating output. Together, the rule verification ratio threshold and the maximum error rate threshold can represent a desired trade-off for the network between rule adherence and model accuracy.

In some examples, a set of rules may be identified, but the strength at which the rules should influence the trained network is unknown. The system searches a plurality of control parameter values for a target control parameter value that causes the trained neural network to generate output with one or more of a rule verification ratio meeting or exceeding the rule verification ratio threshold and an error rate meeting or exceeding the maximum error rate threshold, according to block 630.

The plurality of control parameter values can be sampled from a space in the range [0,1], inclusive. The searching can include sampling a candidate control parameter value and generating a number of network outputs on a validation set of input data. The system can compare the error rate and rule verification ratio of the validation set, and iteratively adjust the control parameter value up or down, repeating the process for a number of iterations.

The system can stop the search upon meeting one or more termination criteria, for example after a certain period of time or iterations has passed, or when a target control parameter value satisfying the maximum error rate threshold and/or the rule verification ratio threshold is identified.

The system processes input data for the trained neural network using the target control parameter value, according to block 640. The process 600 can be repeated for different received datasets, or for a dataset with a distribution shift. The process 600 can also be repeated periodically, for example to ensure that the current control parameter value causes the network to perform at the desired trade-off of accuracy and rule adherence.

In some examples, the process 600 may be performed by the system 100 without identifying a target parameter value. Instead, the system 100 can generate statistics for network quality and rule adherence for a variety of different control parameter values. These statistics can provide insight for a set of rules hypothesized to improve network performance for a given user case. The insight can be used to verify or reject the hypothesized rules, rapidly and without wasted resources in retraining or tuning the network in between iterations of applying different control parameter values.

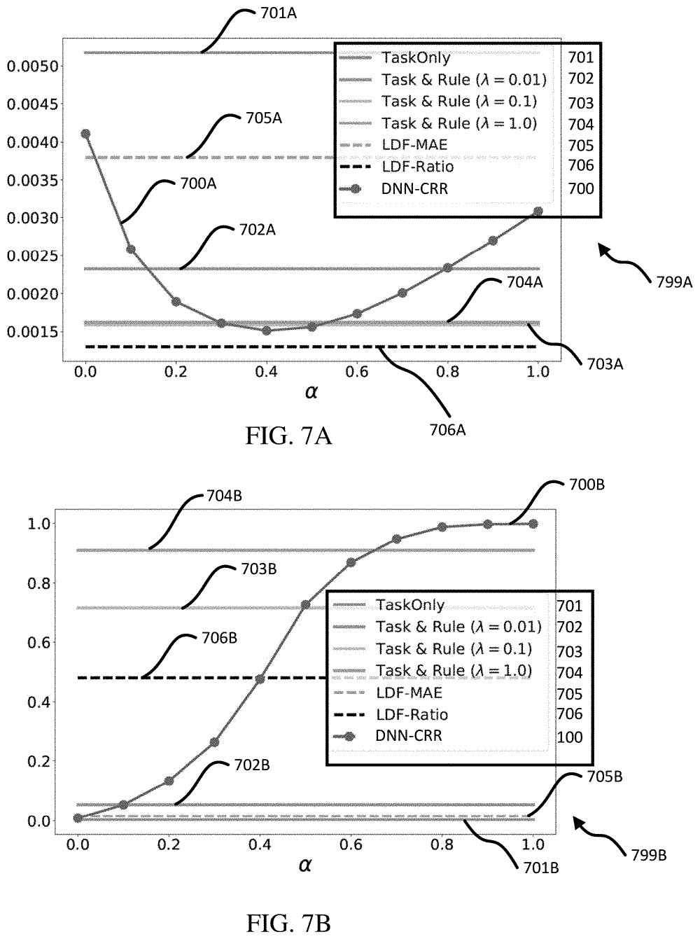

FIGS. 7A-B are graphs illustrating experimental results for an example DNN-CRR system trained to predict future states of a double pendulum, comparing the DNN-CRR system with other training baselines.

FIG. 7A is a graph 799A comparing mean absolute error (MAE) for the DNN-CRR system 100 with other models. TaskOnly model 701 is a DNN performing the same machine learning task with only a data encoder and decision block, and no rule encoder. Task & Rule models 702, 703, and 704 are DNNs with a data encoder, rule encoder, and decision block trained on a fixed control parameter value (shown as δ=0.01, δ=0.1, δ=1.0, respectively). In addition, the DNN-CRR system 100 is compared with two variants of a trained Lagrangian Dual Framework, which enforces rules by solving a constraint optimization problem. LDF-MAE 705 is a Lagrangian Duality Framework (LDF) where the hyperparameter values for training are chosen according to the lowest MAE. LDF-RATIO 706 is an LDF where the hyperparameter values for training are chosen according to the highest rule verification ratio on a validation set. To find these operation points, the LDF is retrained.

The y-axis of the graph 799A tracks the MAE of the various compared models, from 0.0015 to 0.0050. The x-axis of the graph tracks various control parameter values, from 0.0 to 1.0. Note that, as compared with the other models, only the DNN-CRR system 100 can receive different control parameter values, each corresponding to different MAE values as indicated by curve 700A. By contrast, the other models compared without controllable rule representation have the same MAE values, as shown by curves 701A through 706A.

FIG. 7B is a graph 799B comparing rule verification ratios for the DNN-CRR system 100 with other models 701-706. The y-axis of the graph 799B tracks the verification ratio from 0 to 1.0. The x-axis of the graph 799B tracks different control parameter values, from 0.0 to 1.0. Because the models 701-706 cannot receive different control parameter values at inference, the verification ratios shown by curves 701B-706B are constant for the models 701-706, while the curve 700B representing the verification ratio for the DNN-CRR system 100 varies as a function of the control parameter value.

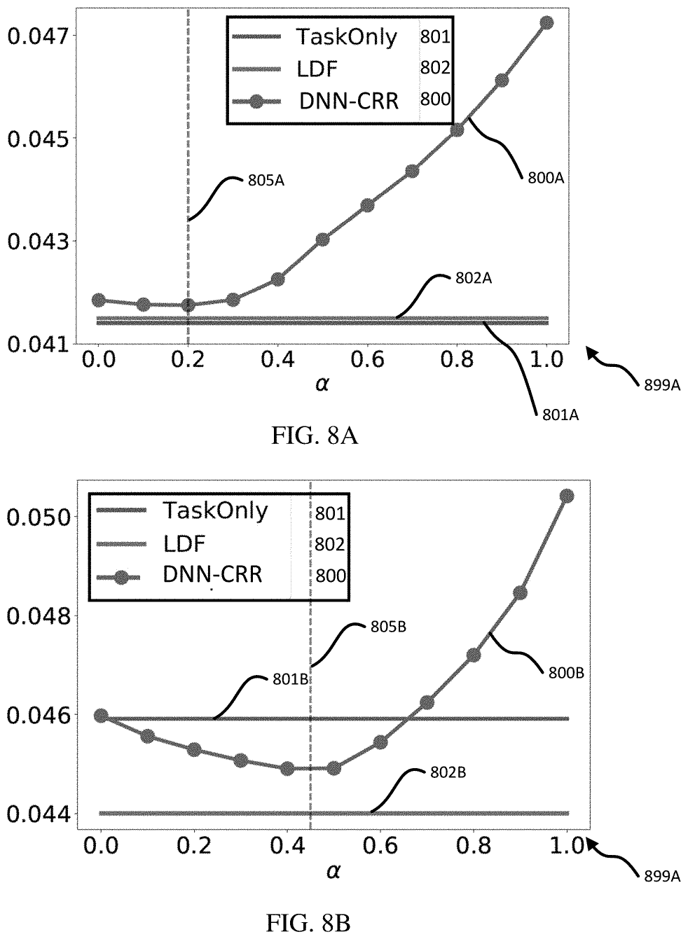

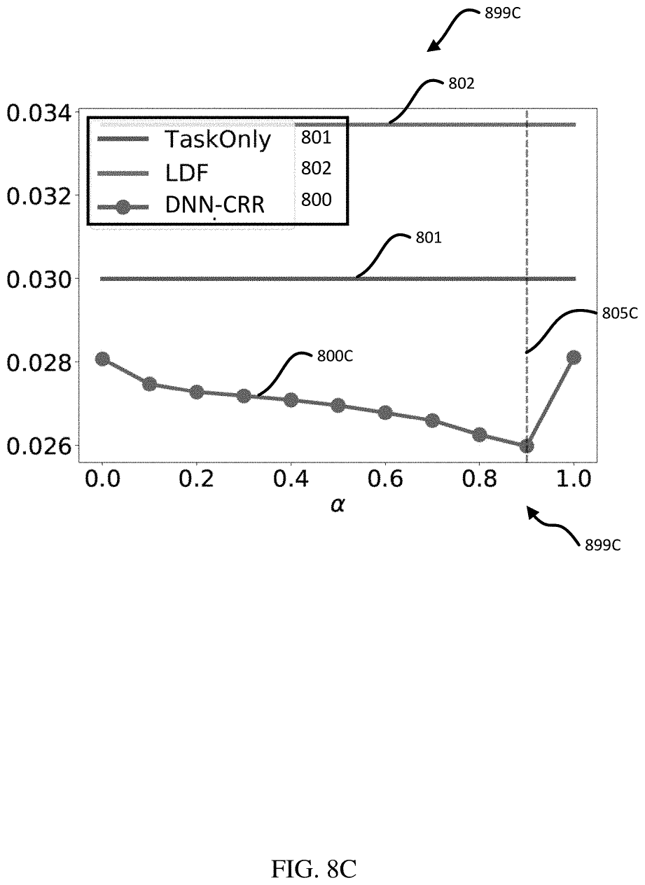

FIGS. 8A-C are graphs 899A-899C illustrating average model errors for a DNN-CRR system 800, according to different rules. The graphs 800A-800C show the average error of the DNN-CRR system 800, LDF 801, and TaskOnly model 802 when trained with different rules. In this example, the models 800, 801, 802 are trained for predicting sales of different goods, with the following rule: “price-difference and sales-difference should have a negative correlation coefficient:

$$r = \frac{Δ SALES}{Δ PRICE} < 0.0 .$$

The graph 800A corresponds to correlation coefficient r<−0.1, the graph 800B corresponds to correlation coefficient r<−0.2, and the graph 800C corresponds to correlation coefficient r<−0.3. The rule can be applied using input perturbation, as described herein with reference to FIGS. 2 and 5. The perturbation can be applied to the price of an item received as a training example. The rule-based objective Lᵣᵤₗₑ can be a function of the perturbed output and the original output, for example Lᵣᵤₗₑ(ŷ,ŷₚ)=ReLU(ŷ−ŷₚ).

Each of the graphs 899A-899C show different control parameter values a applied to the DNN-CRR system 100, along the x-axis (note again the control parameter value is fixed for the TaskOnly model 801 and the LDF 801). The y-axis shows the mean absolute error (MAE) for the different models 800, 801, 802, at different control parameter values. Breakpoints 805A, 805B, and 805C show the control parameter value at which the mean average error is the lowest for the DNN-CRR system 100. Curves 800A-C, 801A-C, and 802A-C correspond to the MAE of the models 800, 801, and 802, respectively.

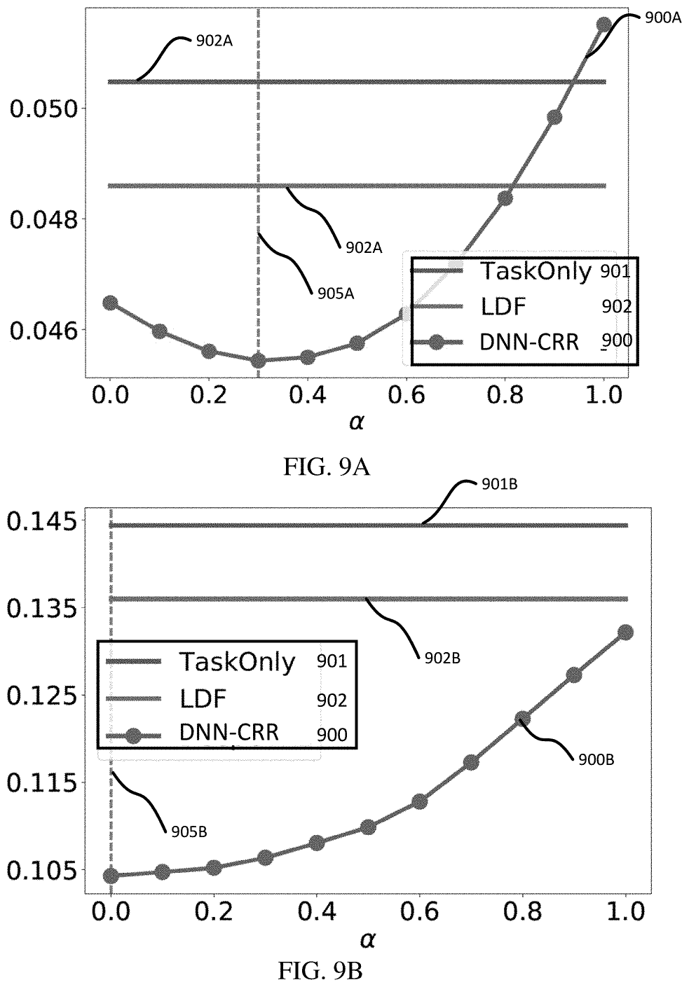

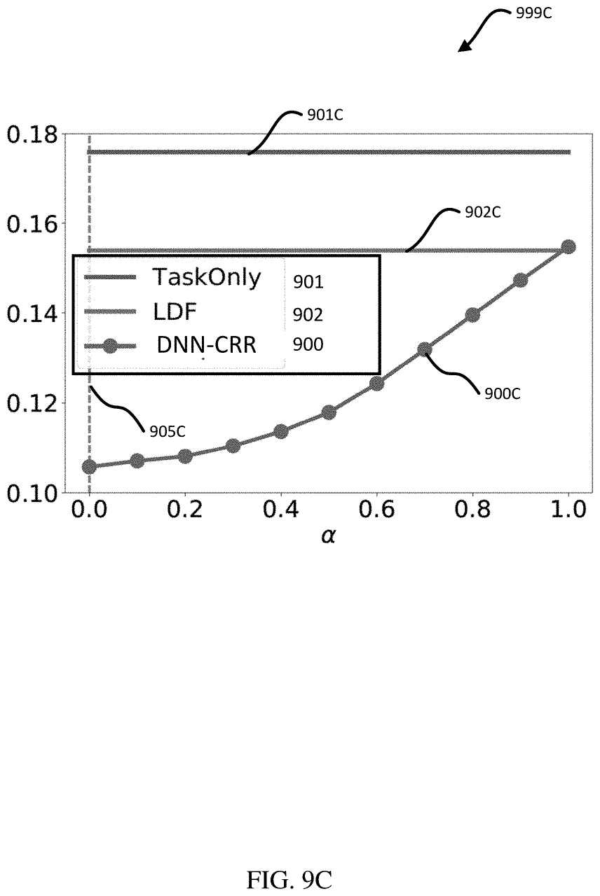

FIGS. 9A-C are graphs 999A-999C illustrating average model error of a DNN-CRR system 900 on unseen test data sets. The models 900-902 are trained to incorporate the correlation coefficient r<0.2, described above with reference to FIG. 8B. As in the graphs 8A-C, the x-axis tracks control parameter values, which remains constant for the TaskOnly model 901 and the LDF 902 but varies with the DNN-CRR system 900. Curves 900-902 The y-axis shows the MAE for the different models. Breakpoints 905A 905B, 906B show how the performance of the DNN-CRR system 900 can be adapted for different datasets, by varying the control parameter value at inference. For instance, for a first dataset evaluated by the DNN-CRR system 900 according to FIG. 9A, the control parameter value causing the lowest error is 0.3.

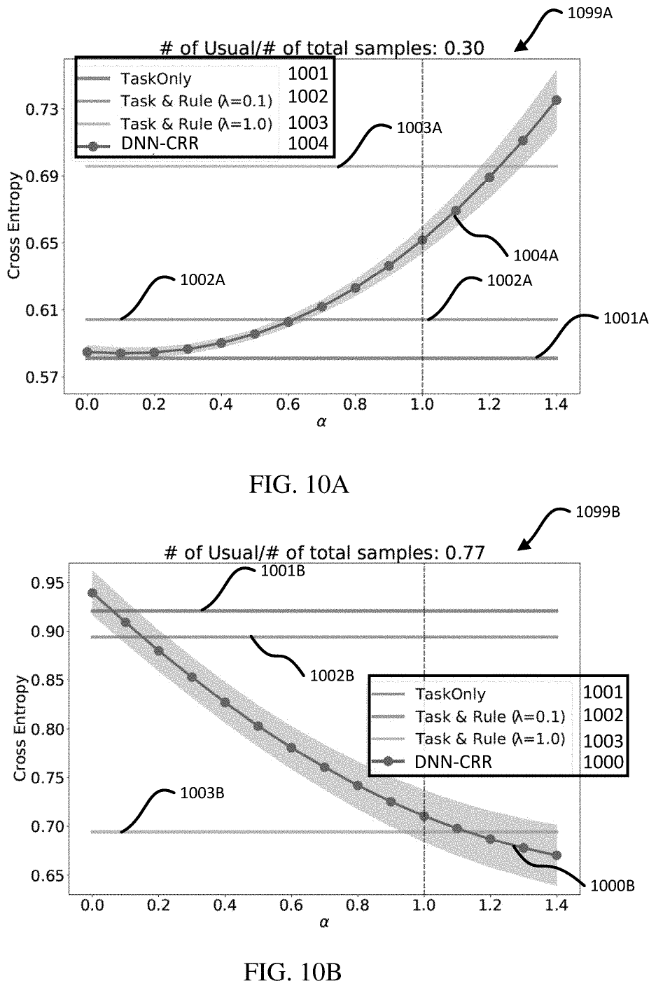

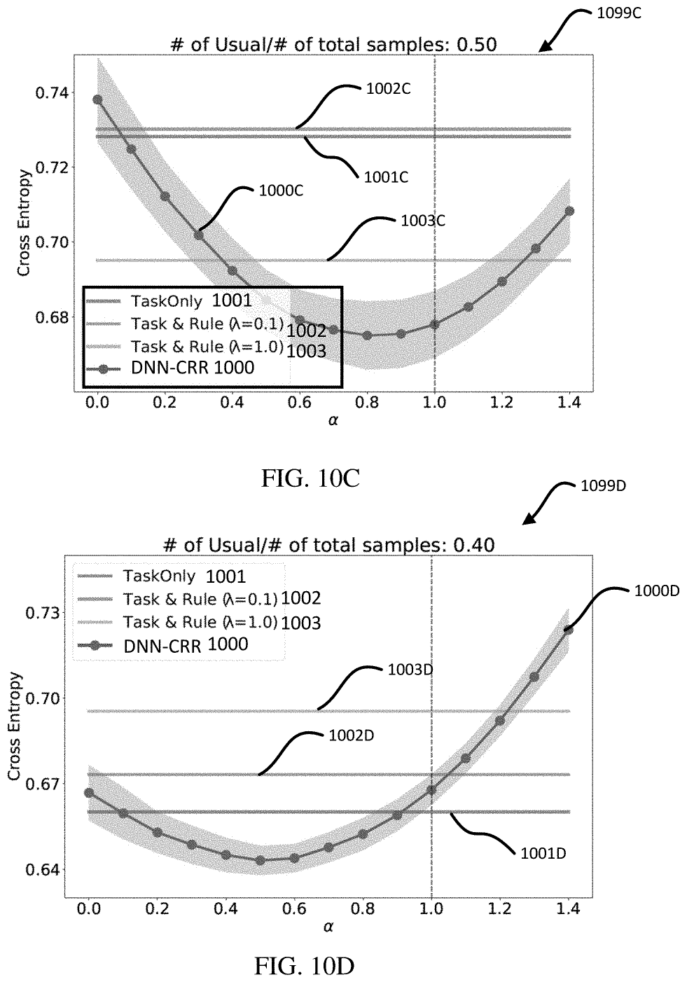

FIGS. 10A-D are graphs 1099A-1099D illustrating cross-entropy loss of a DNN-CRR system 1000 on different input datasets with distribution shifts. As described herein, the DNN-CRR system can adapt to distribution shifts by controlling the control parameter value, avoiding the need for fine-tuning or training from scratch. The models 1000-1004 have been trained for classifying cardiovascular disease in a patient, based on physiological measurements and the medical history of the patient.

Given that higher systolic blood pressure is known to be strongly associated with cardiovascular disease, the models 1000-1004 are trained according to the following systolic blood pressure rule ŷ_{p,i}>ŷᵢ if x_{p,i}^{press}>xᵢ^{press}, where the perturbed output ŷ_{p,i} for a perturbed input x_{p,i} representing the i-th patient is greater than the model output representing the probability of cardiovascular disease ŷᵢ, if the blood pressure of the i-th patient in the perturbed input x_{p,i}^{press} is greater than the blood pressure of the i-th patient before perturbing the input xᵢ^{press}.

The subscript p represents perturbations to the input and output. This rule can be fitted to a decision tree, for example by the DNN-CRR system or other system of one or more processors using any of a variety of techniques for training a decision tree, to further identify a threshold blood pressure value at which patients are more likely to have cardiovascular disease. In one example, it was observed that if a patient has a systolic blood pressure higher than 129.5, more than 70% of patients were found to have cardiovascular disease. Based on this information and the above rule, patients can be split into two groups, labeled UNUSUAL and USUAL, respectively:

(UNUSUAL) {i:{xᵢ^{press}<129.5∩yᵢ=1}∪{xᵢ^{press}≤129.5∩yᵢ=0}

(USUAL) {i:{xᵢ^{press}<129.5∩yᵢ=0}∪{xᵢ^{press}≤129.5∩yᵢ=1}

A patient i falls under the UNUSUAL group if they are either predicted to have cardiovascular disease (yᵢ=1) with a blood pressure less than 129.5 (xᵢ^{press}<129.5), or predicted to not have cardiovascular disease (yᵢ=0) but has a systolic blood pressure greater than or equal to 129.5. The opposite holds for a patient falling under the USUAL group. The majority of the patients in the UNUSUAL group are likely to have cardiovascular disease even though their blood pressure is relatively lower, and vice versa for the patients in the USUAL group.

Depending on the ratio of UNUSUAL to USUAL patients in a given state, a higher rule strength for the systolic blood pressure rule may lead to less accurate results. The graphs in FIGS. 10A-D illustrate how the error can be controlled using an adjustable control parameter value and the DNN-CRR system.

Task & Rule models 1002 and 1003 are models trained with a fixed control parameter value (shown as λ), to differentiate from the controllable control parameter value a received by the DNN-CRR system 1000. Task & Rule model 1002 is trained with rules and a fixed control parameter value of 0.1, while Task & Rule model 1003 is trained with rules and a fixed control parameter value of 1.0. The TaskOnly model 1001 is trained without rules. The y-axis shows the cross-entropy loss of the models 1000-1003. Graph 1099A shows cross-entropy losses 1000A-1003A for the models on a dataset with 0.3 ratio of USUAL to total number of patients (where the total is equal to the number of USUAL patients plus the number of UNUSUAL patients). Graphs 1099B, 1099C, and 1099D show cross-entropy losses of the models for USUAL-to-total patient ratios of 0.77, 0.50, and 0.40, respectively. The cross-entropy losses for the models 1000-1003 are shown as curves 1000B-1003B, 1000C-1003C, and 1003D, respectively.

The control parameter value resulting in the lowest cross-entropy loss for the DNN-CRR system changes with the distribution of USUAL and UNUSUAL patients. For example, when the ratio of patients from USUAL is decreased, the best control parameter value is an intermediate value between 0 and 1, for example as shown in graphs 1099A, 1099C, and 1099D. This demonstrates that the DNN-CRR system can adapt a trained model through the control parameter value towards better-performing behavior if the rule is beneficial for the target domain. As the control parameter value resulting in the lowest error approaches one, the rule is expected to be valid for more patients, unlike in the case of FIG. 9C, in which the ratio 0.5 and the error increases as the control parameter passes and exceeds one.

FIGS. 11A-11B are graphs 1199A-1199B comparing cross-entropy and model accuracy versus rule strength for various upper bounds of a perturbation scale. A perturbation value is sampled from a distribution uniformly, having a lower bound of zero and an upper bound of u. When the upper bound u is increased, the perturbation scale y can also be increased, thus leading to larger perturbations δx.

FIG. 11A is an example graph comparing cross-entropy loss for different upper bounds of a perturbation scale. The y-axis of graph 1199A ranges from 0.575 to 0.775 and represents cross-entropy loss. The x-axis of graph 1199A ranges from 0.0 to 1.0 and represents different control parameter values. The cross-entropy for a TaskOnly network 1101 is shown as curve 1101A and is compared with the cross entropies for networks trained for controllable rule representations, with input perturbation at different upper bounds. Specifically, upper bounds u=0.001, u=0.01, u=0.1, u=1.0, and u=10.0 are shown, corresponding to curves 1102A-1106A, respectively. The graph 1199A illustrates a trade-off between incorporating input perturbance for handling non-differentiable rule-based objectives, and cross-entropy loss, as the loss increases when the upper bound u and the control parameter value is increased. Too small perturbation incorporates fewer rule latent representations, however, too large perturbations and the network may be dominated by the rules mostly, with performance worsening as the control parameter value approaches zero.

FIG. 11B is an example graph 1199B comparing network accuracy versus rule strength for different upper bounds of the perturbation scale. The y-axis of graph 1199B ranges from 0.55 to 0.7 and represents network accuracy. The x-axis of graph 1199B ranges from 0.0 to 1.0 and represents different control parameter values. The accuracies for a TaskOnly network 1101 are represented as curve 1101B is compared with curves 1102B-1106B for models trained for controllable rule representations, as described herein with reference to FIG. 11A. The graph 1199B illustrates a trade-off between incorporating input perturbance for handling non-differentiable rule-based objectives, and model accuracy, as the loss increases when the upper bound u and the control parameter value is increased.

### Example Computing Environment

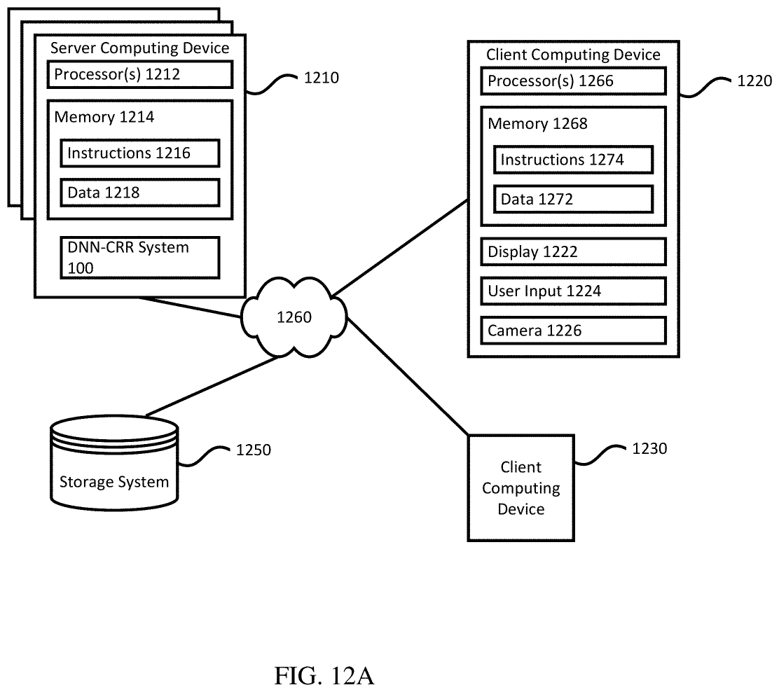

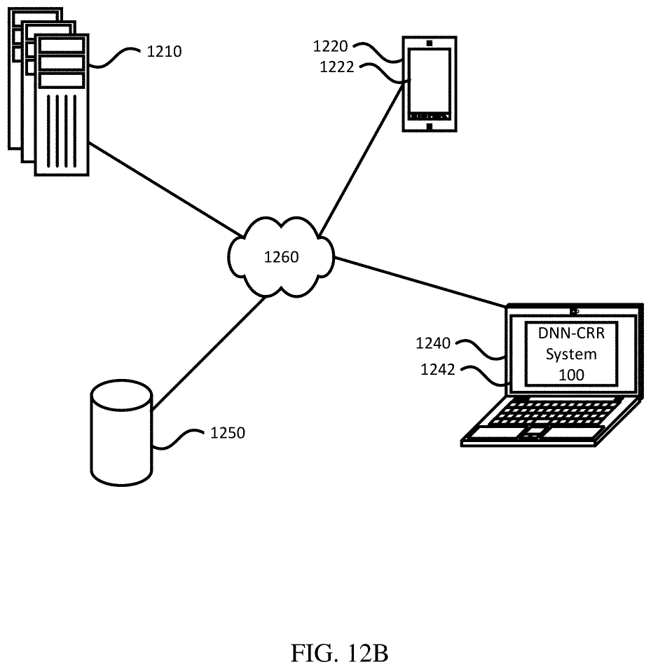

FIGS. 12A and 12B show an example of the DNN-CRR system 100 implemented on one or more computing devices. In this example, the system 100 can be implemented on one or more of computing devices 1210, 1220, 1230 and 1240 as well as on a storage system 1250. The computing device 1210 can include one or more processors 1212, memory 1214 and other components typically present in general purpose computing devices. The memory 1214 of the computing device 1210 can store information accessible by the one or more processors 1212, including instructions 1216 that can be executed by the one or more processors 1212 to cause the computing device 1210 to perform operations for with controllable rule representation, consistent with aspects of this disclosure.

Memory can also include data 1218 that can be retrieved, manipulated, or stored by the processor. The memory can be of any non-transitory type capable of storing information accessible by the processor, such as a hard-drive, memory card, ROM, RAM, DVD, CD-ROM, write-capable, and read-only memories. The instructions 1216 can be any set of instructions to be executed directly, such as machine code, or indirectly, such as scripts, by the one or more processors. In that regard, the terms “instructions,” “application,” “steps,” and “programs” can be used interchangeably herein. The instructions can be stored in object code format for direct processing by a processor, or in any other computing device language including scripts or collections of independent source code modules or engines that are interpreted on demand or compiled in advance. Functions, methods, and routines of the instructions are explained in more detail below. Example instructions may include a web application.

The data 1218 may be retrieved, stored, or modified by the one or more processors 1212 in accordance with the instructions 1216. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII, or Unicode. Moreover, the data can include any information sufficient to identify the relevant information, such as numbers, descriptive text, proprietary codes, pointers, references to data stored in other memories such as at other network locations, or information that is used by a function to calculate the relevant data.

The one or more processors 1212 can be any conventional processors, such as a commercially available CPU. Alternatively, the processors can be dedicated components such as field-programmable gate arrays (“FPGA”), an application specific integrated circuit (“ASIC”) (including tensor processing units (“TPUs”)) or another hardware-based processor. Although not necessary, one or more of computing devices 1210, 1220, 1230, and 1240 may include specialized hardware components to perform specific computing processes, such as parallel processing. For instance, the one or more processors 1212 can be graphics processing units (“GPU”). Additionally, the one or more GPUs or other devices may be single instruction, multiple data (“SIMD”) devices and/or single instruction, multiple thread devices (“SIMT”).

Although FIG. 12A functionally illustrates the processor, memory, and other elements of computing device 1210 as being within the same block, the processor, computer, computing device, or memory can include multiple processors, computers, computing devices, or memories that may or may not be stored within the same physical housing. For example, the memory can be a hard drive or other storage media located in a housing different from that of the computing devices 1210-1240. Accordingly, references to a processor, computer, computing device, or memory will be understood to include references to a collection of processors, computers, computing devices, or memories that may or may not operate in parallel. For example, the computing devices 1210-1240 may include server computing devices operating as a load-balanced server farm, distributed system, etc.

Although some functions or operations described below are indicated as taking place on a single computing device having a single processor, various aspects of the subject matter described herein can be implemented by a plurality of computing devices, for example, communicating information over network 1260.

Each of the computing devices 1210-1240 can be at different nodes of a network 1260 and capable of directly and indirectly communicating with other nodes of network 1260. Although only a few computing devices are depicted in FIGS. 12A-12B, it should be appreciated that a typical system can include a large number of connected computing devices, with each different computing device being at a different node of the network 1260. The network 1260 and intervening nodes described herein can be interconnected using various protocols and systems, such that the network 1260 can be part of the Internet, World Wide Web, specific intranets, wide area networks, or local networks.

The network 1260 can support a variety of short- and long-range connections. The short- and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 560, in addition or alternatively, can also support wired connections between the devices 512, 515, including over various types of Ethernet connection.

Although certain advantages are obtained when information is transmitted or received as noted above, other aspects of the subject matter described herein are not limited to any particular manner of transmission of information.

As an example, the computing device 1210 may include web servers capable of communicating with storage system 1250 as well as computing devices 1220, 1230, and 1240 via the network. For example, one or more of the server computing devices 1210 may use network 1260 to transmit and present information, web applications, etc., on a display, such as display 1222 of the computing device 1220. In this regard, the computing devices 1220, 1230, and 1240 may be considered client computing devices and may perform all or some of the features described herein.

Each of the client computing devices 1220 and 1230 may be configured similarly to the server computing devices 1210, such as with one or more processors 1266, memory 1268, data 1272, and instructions 1274, as described above. Each client computing device 1220, 1230, or 1240 may be a personal computing device intended for use by a user, and have all of the components normally used in connection with a personal computing device such as a central processing unit (CPU), memory, for example, RAM and internal hard drives, storing data and instructions, a display such as display 1222, for example a monitor having a screen, a touch-screen, a projector, a television, or other device that is operable to display information, and user input 1224, for example a mouse, keyboard, touchscreen, or microphone. The client computing device may also include a camera for recording video streams and/or capturing images, speakers, a network interface device, and all of the components used for connecting these elements to one another.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

While operations shown in the drawings and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, and engines described can be integrated together as a single system or be part of multiple systems.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising one or more processors, the one or more processors configured to:
train, by the one or more processors, a machine learning model to process input data, wherein the machine learning model is trained to:
receive input data;
receive a control parameter value corresponding to a degree at which output data generated by the machine learning model adheres to one or more rules; and
generate the output data in accordance with a machine learning task, using the input data, the control parameter value, and the one or more rules.

2. The system of claim 1, wherein the one or more processors are further configured to:
receive a first control parameter value and first input data;
process the first input data to generate first output data using the trained machine learning model, the first control parameter value, and the one or more rules;
receive a second control parameter value and second input data, the first control parameter value different from the second control parameter value; and
process the second input data to generate second output data using the trained machine learning model, the second control parameter value, and the one or more rules.

3. The system of claim 2,
wherein the trained machine learning model comprises model parameter values, and
wherein the model parameter values for the machine learning model are not updated in between processing the first input data and the second input data.

4. The system of claim 1,
wherein the machine learning model comprises a rule encoder, a data encoder, and a decision block, and
wherein in training the machine learning model, the one or more processors are configured to:
generate a data latent representation of the input data using the data encoder and a rule latent representation of the input data using the rule encoder;
concatenate the data latent representation and the rule latent representation using a control parameter value sampled from a probability distribution to generate a concatenated representation;
generate, from the decision block receiving the concatenated representation, output data corresponding to the input data; and
update model parameter values for one or more of the rule encoder, the data encoder, and the decision block, based at least in part on an error calculated between the output data and a ground-truth label.

5. The system of claim 4,
wherein in training the machine learning model, the one or more processors are configured to perform one or more iterations of generating the data latent representation and the rule latent representation, concatenating the data latent representation and the rule latent representation, and generating the output data from the decision block receiving the concatenated representation, and
wherein for each iteration of the one or more iterations, the one or more processors are configured to sample a respective control parameter value from a probability distribution.

6. The system of claim 5, wherein the one or more processors are configured to sample from the probability distribution weighted to sample zero or one at the ends of the sampled range more often than values within the sampled range that are not zero or one.

7. The system of claim 1, wherein in training the machine learning model, the one or more processors are configured to:
train the machine learning model using a compound objective function comprising a task-based objective function and a rule-based objective function, wherein the output of the rule-based objective function is scaled according to the sampled control parameter value.

8. The system of claim 7,
wherein the machine learning model comprises model parameters,
wherein the rule-based objective function is non-differentiable with respect to model parameter values of the machine learning model, and
wherein the one or more processors are configured to:
receive a training example;
perturb the training example according to a predetermined factor; and
process the rule-based objective function using at least the training example and the perturbed training example, wherein the output of the rule-based objective function is based on whether the training example and the perturbed training example adhere to the one or more rules.

9. The system of claim 1, wherein the one or more processors are further configured to:
receive a rule verification ratio threshold; and
search a plurality of control parameter values for a target control parameter value that causes the trained machine learning model to generate output with a rule verification ratio meeting or exceeding the rule verification ratio threshold.

10. The system of claim 9, wherein in determining the target control parameter value, the one or more processors are further configured to:
receive a maximum error rate threshold specifying a maximum error rate for output data generated by the trained machine learning model; and
search for a target control parameter value that causes the trained machine learning model to generate output data with the rule verification ratio meeting or exceeding the rule verification ratio threshold and having an accuracy meeting or exceeding the maximum error rate.

11. The system of claim 1, wherein the machine learning model is a deep neural network.

12. A method comprising:
training, by one or more processors, a machine learning model to:
receive input data;
receive a control parameter value corresponding to a degree at which output data generated by the machine learning model adheres to one or more rules; and
generate the output data in accordance with a machine learning task, using the input data, the control parameter value, and the one or more rules.

13. The method of claim 12, further comprising:
receiving, by the one or more processors, a first control parameter value and first input data;
processing, by the one or more processors, the first input data to generate first output data using the trained machine learning model, the first control parameter value, and the one or more rules;
receiving, by the one or more processors, a second control parameter value and second input data, the first control parameter value different from the second control parameter value; and
processing, by the one or more processors, the second input data to generate second output data using the trained machine learning model, the second control parameter value, and the one or more rules.

14. The method of claim 13,
wherein the trained machine learning model comprises model parameter values, and
wherein the model parameter values for the machine learning model are not updated in between processing the first input data and the second input data.

15. The method of claim 12,
wherein the machine learning mod3e1 comprises a rule encoder, a data encoder, and a decision block, and
wherein training the machine learning model comprises:
generating a data latent representation of the input data using the data encoder and a rule latent representation of the input data using the rule encoder;
concatenating the data latent representation and the rule latent representation using a control parameter value sampled from a probability distribution to generate a concatenated representation;
generating, from the decision block receiving the concatenated representation, output data corresponding to the input data; and
updating model parameter values for one or more of the rule encoder, the data encoder, and the decision block, based at least in part on an error calculated between the output data and a ground-truth label.

16. The method of claim 15,
wherein training the machine learning model comprises:
performing one or more iterations of generating the data latent representation and the rule latent representation, concatenating the data latent representation and the rule latent representation, and generating the output data from the decision block receiving the concatenated representation, and
for each iteration of the one or more iterations, sampling a respective control parameter value from a probability distribution.

17. The method of claim 16, wherein the sampling comprises sampling from the probability distribution weighted to sample zero or one at the ends of the sampled range more often than values within the sampled range that are not zero or one.

18. The method of claim 12, wherein training the machine learning model further comprises:
training the machine learning model using a compound objective function comprising a task-based objective function and a rule-based objective function, wherein the output of the rule-based objective function is scaled according to the sampled control parameter value.

19. The method of claim 18,
wherein the machine learning model comprises model parameters,
wherein the rule-based objective function is non-differentiable with respect to model parameter values of the machine learning model, and
wherein the method further comprises:
receiving, by the one or more processors, a training example;
perturbing, by the one or more processors, the training example according to a predetermined factor;
processing, by the one or more processors, the rule-based objective function using at least the training example and the perturbed training example, wherein the output of the rule-based objective function is based on whether the training example and the perturbed training example adhere to the one or more rules.

20. A system comprising one or more processors, the one or more processors configured to:
receive, by the one or more processors, input data for processing at a machine learning model trained to receive a control parameter value corresponding to a degree at which output data generated by a machine learning model adheres to one or more rules;
receive, by the one or more processors, a control parameter value; and
generate, by the one or more processors and from the machine learning model, output data using the input data and the control parameter value.
